(19) United States
(12) Patent Application Publication
(10) Pub. No.: US 2010/0065800 A1
(43) Pub. Date: Mar. 18, 2010

(54) LIFT FOR MOTORCYCLES AND THE LIKE, OFFERING MOBILITY OF OMNIDIRECTIONAL MOVEMENT

(76) Inventor: Giuliano GIUSTINI, Siena (IT)

Correspondence Address: MCGLEW & TUTTLE, PC, P.O. BOX 9227, SCARBOROUGH STATION, SCARBOROUGH, NY, 10510-9227, US

(21) Appl. No.: 12/513,550

(22) PCT Filed: Nov. 7, 2007
(86) PCT No.: PCT/IT07/00783

§ 371 Date: May 5, 2009

(30) Foreign Application Priority Data
Nov. 8, 2006 (IT) FI2006A000277

(51) Int. Cl. B66F 5/02

(52) U.S. Cl. 254/8 R

(57) ABSTRACT

The lift comprises: a dolly (1) with wheels (3, 5) forming a supporting polygon; a lift element (11, 11A, 13) constrained with joints (9) to said dolly (1) and forming a maneuvering lever (11A), with angled projections (13) forming or carrying housings for contact with members of a wheel or in proximity of a wheel of a motor vehicle; and supports (7 or the like) capable of being moved to allow the lift element to rest on the ground and respectively to interfere with said lift element, to prevent it from resting on the ground.

The invention relates to a lift for lifting a wheel of a motorcycle or other equivalent motor vehicle or the like, which offers wide possibilities of use, in particular for moving the raised motor vehicle and for facilitate maneuvering thereof. These and other objects and advantages will be apparent in the text below.

In substance, the lift in question comprises:
a dolly with wheels forming a supporting polygon and capable of movements on the ground;
a lift element constrained with joints to said dolly and forming a maneuvering lever to lift the wheel of the motor vehicle; and
means to allow said lift element to rest on the dolly or on the ground.

In this manner it is possible to move the assembly formed by the lift and by the motor vehicle with the wheel raised with extreme ease by moving the dolly, or to maintain the assembly in one position. The maneuver to lift the motor vehicle is also facilitated.

More specifically, said lift element can be provided with angled projections forming or carrying housings for contact with members of a wheel or in proximity of a wheel of the motor vehicle. Moreover, supports are provided, capable of being moved to allow the lift element to rest on the ground and respectively to interfere with said lift element, so as to prevent it from resting on the ground.

Said supports can be constituted by pins sliding between an active position and an excluded position. These supports—pins or the like—can advantageously be mounted on the dolly.

The joints of the lift element on the dolly are advantageously positioned to define a pivot axis which is on one side between and in the vicinity of one side of the supporting polygon of the dolly, and on the other side in the vicinity of the perpendicular from the ends of the projections of said lift element. In this manner, maneuvers of the lift element are facilitated and the position of said lift element is made stable in the arrangements in which it is to be positioned.

The invention will be better understood by following the description and accompanying drawing, which shows a non-limiting practical example of the invention. In the drawing:

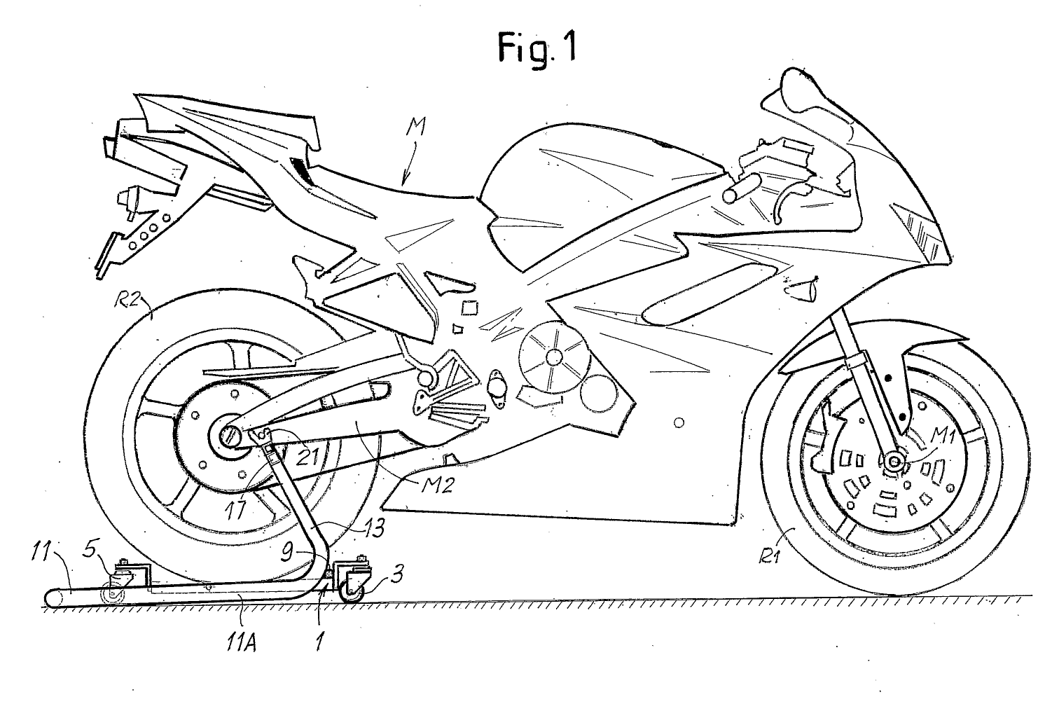

FIG. 1 shows a side view of the lift about to receive a motor cycle in immobile conditions with the rear wheel raised slightly;

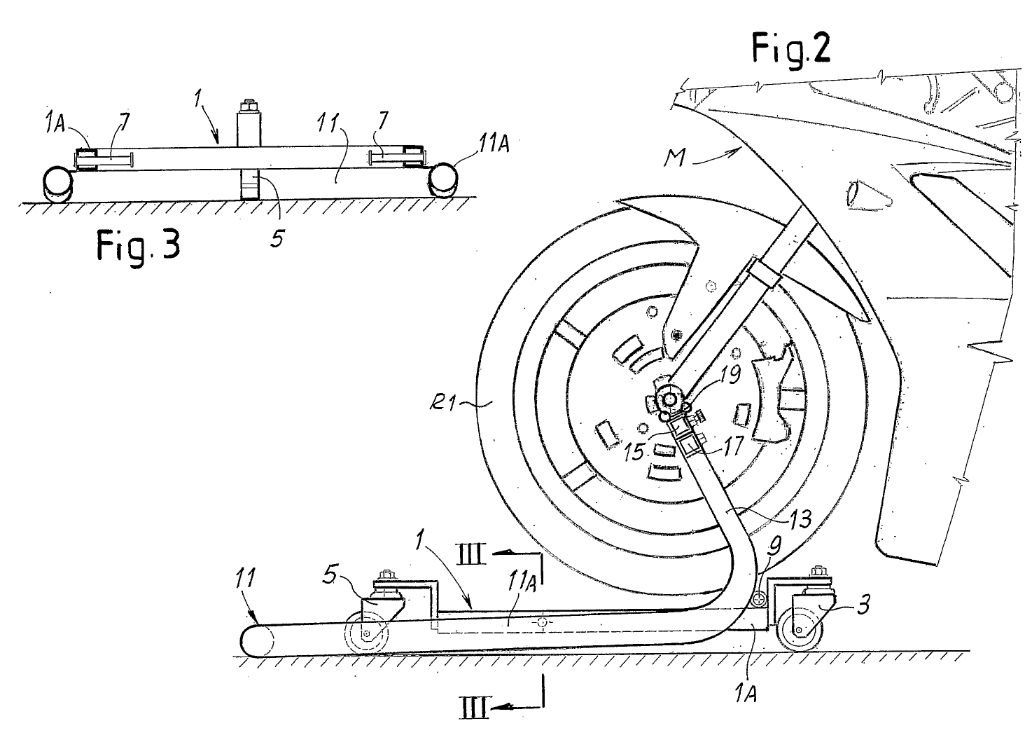

FIGS. 2 and 3 show a side view of a detail in the arrangement of stable support of the motor vehicle with the front wheel slightly raised in immobile conditions, and a local section according to in FIG. 2;

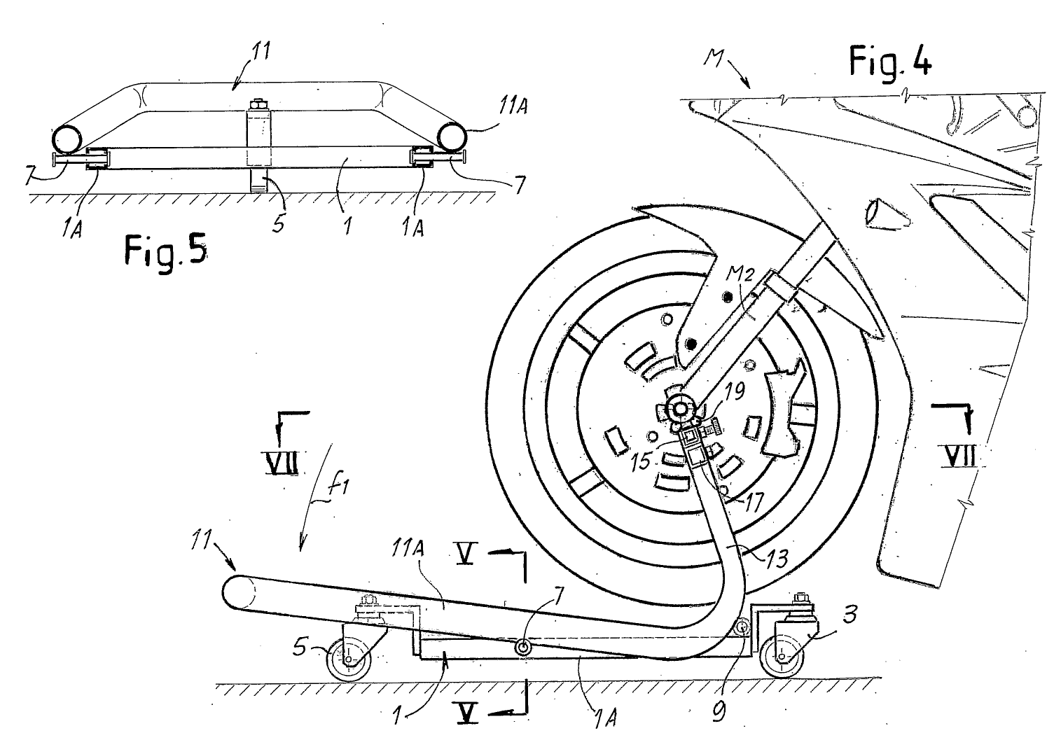

FIGS. 4 and 5 show, analogously to FIGS. 2 and 3 (with section V-V in FIG. 4), the motor vehicle in the conditions with the front wheel raised to allow movement thereof;

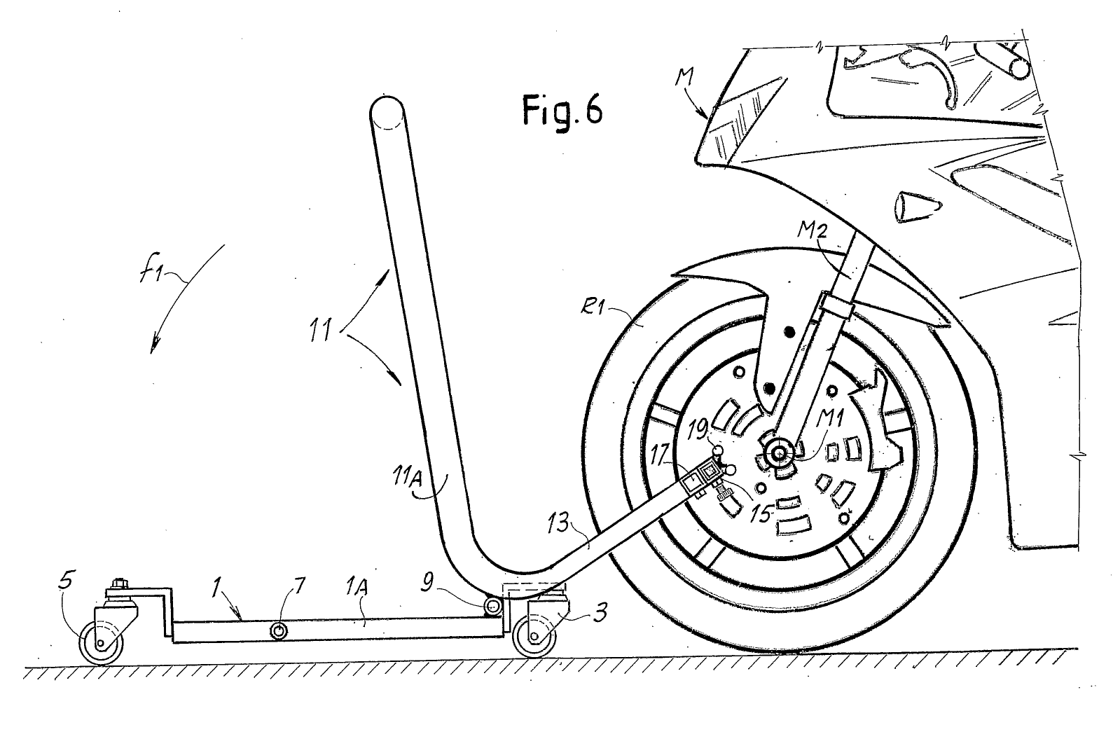

FIG. 6 shows the lift about to be maneuvered to perform lifting of the front wheel; and

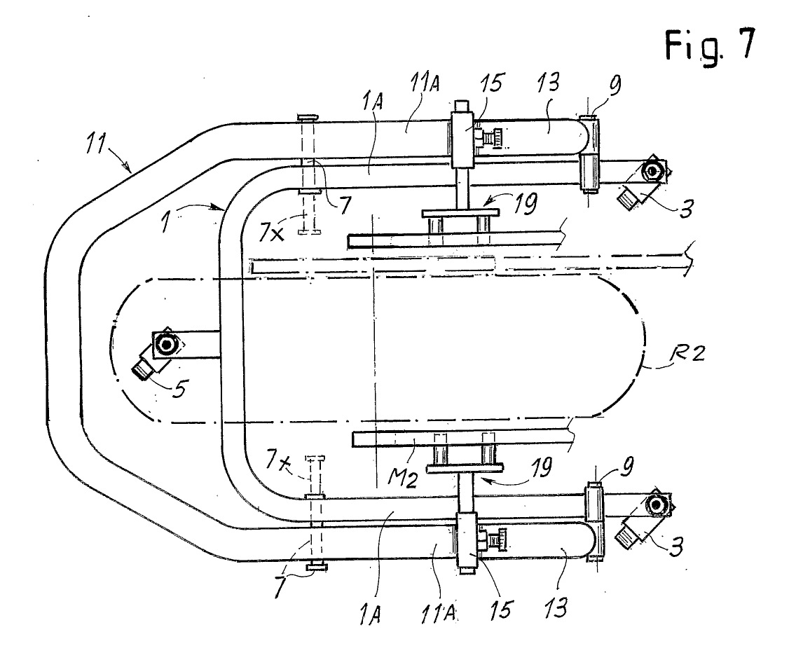

FIG. 7 shows a local section according to VII-VII in FIG. 4.

According to the example shown, the lift in question comprises a U-shaped dolly 1 provided with two adjacent wheels 3 and a third wheel 5 freely swiveling and defining the supporting polygon of the dolly. Said dolly 1 has along the two parallel sides 1A two respective supports—such as pins 7 or the like—capable of being moved—in particular of sliding axially according to a horizontal axis—so that each of them can be made to project toward the inside of the side 1A or excluded from said arrangement and toward the outside, in the arrangement 7X in FIGS. 5 and 7. These pins form an example of support means that allow the dolly 1 to be moved in any direction when pushed. The support means can also be designed in another manner, e.g. by making them tip angularly between an active and an inactive position, in any case to obtain the functions explained below.

The wheels 3, 3, 5 define a triangular supporting polygon of the dolly 1.

Angularly constrained to the dolly 1, by mean of a double horizontal joint 9 on the sides 1A of the dolly 1 in proximity of the wheels 3, is a lift element 11 extending as a U-shaped lever with the joints 9, which are positioned at the ends of the two sides 11A parallel with each other and spaced apart from each other by a distance which is slightly greater than the distance between the two sides 1A of the dolly 1. Therefore, said lift element 11 can be moved—about the joints 9—both above and below the dolly 1.

Each of the two sides 11A of the lift element 11 extends with a projection 13 above the sides 11A of the element 11 and limitedly inclined from the vertical and toward the wheel 5. Each of said projections 13 is provided at the end with one or preferably two housings 15 and 17. The housing 15 is intended to receive one or other of two supporting members 19 and 21. The supporting member 19 with two dowels is suitable to be oriented to lift the front fork M1 of the motor vehicle M and consequently lift the front wheel R1; the other supporting member 21 is fork-shaped and is suitable to engage one side of the fork M2 of the rear wheel R2 of the motor vehicle M (as can be seen in FIG. 1), to lift said wheel R2. The other 17 of said housings 15, 17 can be used to receive the supporting member not used.

The joints 9 are positioned so that when the lift member 11 is resting on the ground (see FIGS. 1 and 2) said joints 9 are just inside the supporting polygon of the dolly, between the periphery of said supporting polygon defined by the wheels 3 and the perpendicular at the ends of the projections 13 when the lift element 11 is lowered.

With the assembly described, it is possible to move the dolly 1 with the lift element 11 inclined—as indicated in FIG. 6—until the projections 13 with the supporting member 19 are level with the hub of the fork M1 of the front wheel R1 (FIGS. 6, 2 and 4) or in proximity of the fork M2 of the rear wheel R2 (FIG. 1); in this way the wheel can be lifted by lowering the lift element 11, 11A according to the arrow f1 in FIGS. 2, 4 and 6. If the two supporting means—such as the two pins 7—have been moved inward in the arrangement 7X indicated with dashed and dotted line in FIG. 7 and as indicated in FIG. 3 or in any case so that they do not interfere with the element 11, the lift element 11 rests on the ground (FIGS. 1 and 2) and the wheel (R1 or R2) is thus raised but the motor vehicle 1 remains steady as the element 11 is resting on the ground. If, however, it is necessary to move the motor vehicle with the wheel (R1 or R2) raised, before lowering the element 11 completely the support means are inserted in conditions of interference with said element 11—according to the example the pins 7 are moved outward (FIGS. 4, 5 and 7)—and therefore the lift element 11 rests on the pins 7 (or on the other support means) and remains raised from the ground, so that the dolly with the motor vehicle M with the wheel (R1 front or R2 rear) raised forms an assembly that can be maneuvered with the wheels 3, 3, 5 and with the raised wheel of the motor vehicle, to a desired different position. In any desired position the assembly of the dolly and of the motor vehicle can be braked by lowering the lift element onto the ground through extraction of the pins 7.

In practice, by using two dollies 1 equipped as described, both wheels of the motor vehicle can be raised simultaneously to facilitate maneuvering.

In any case, maneuvers are extremely easy as implemented by acting on the element 11 practically without any effort and by easily maneuvering the pins 7 or other equivalent supporting means. Movements on the ground are easy as the assembly of the dolly or dollies and of the motor vehicle (in the conditions in FIG. 4) is resting on the three swiveling wheels 3, 3, 5 and on the only wheel of the motor vehicle not raised, or preferably with both wheels R1 and R2 raised using two dollies 1 simultaneously. Constraint in the desired position reached is easily obtained by lifting the element 11 slightly and moving the pins 7 inward (FIG. 3) or in any case the supporting members into the inactive position, to rest the element 11, or each element 11, on the ground and always maintaining the wheel or wheels of the motor vehicle raised.

It is understood that the drawing only shows an example provided by way of a practical arrangement of the invention, and that said invention can vary in shapes and arrangement without however departing from the scope of the concept on which said invention is based. Any reference numerals in the appended claims are provided to facilitate reading of the claims with reference to the description and to the drawing, and do not limit the scope of protection represented by the claims. For example, the movable supporting means—such as the pins 7 or equivalent tipping members—can be provided on the supporting element 11 instead of on the dolly 1, always to perform the function of preventing the element 11 from resting on the ground.

1. A lift for lifting a wheel of a motorcycle or other equivalent motor vehicle or the like, the lift comprising
a dolly with wheels forming a supporting polygon and capable of movements on the ground;
a lift element constrained with joints to said dolly and forming a maneuvering lever to lift the wheel of the motor vehicle; and
a supporting means movable to allow said lift element to rest on the dolly, or excluded to allow said lift element to rest on the ground.

2. A lift as claimed in claim 1, wherein said supporting means comprises supports on said dolly or on said lift element, said supports being capable of being moved to support the lift element to prevent said lift element from resting on the ground and respectively to withdraw from said lift element to allow said lift element to rest on the ground.

3. A lift as claimed in claim 2, wherein said supports are pins sliding between an active position and an excluded position.

4. A lift as claimed in claim 2, wherein said supports are mounted on the dolly.

5. A lift as claimed in claim 1, wherein said lift element comprises angled projections forming or carrying housings for contact members contacting members of a wheel or in proximity of a wheel of the motor vehicle.

6. A lift as claimed in claim 1, wherein said joints define a pivot axis which is between and in the vicinity both of one side of the supporting polygon of the dolly and of the perpendicular from the ends of the projections of said lift element when activated for lifting.

7. A lift as claimed in claim 1, wherein two of said lifts are provided, on both wheels of the motor vehicle.

8. (canceled)
